(19) United States
(12) Patent Application Publication
(10) Pub. No.: US 2006/0134981 A1
(43) Pub. Date: Jun. 22, 2006

(54) Electrical receptacle

(76) Inventor: Jo-Ellen Foore, Toledo, OH (US)

Correspondence Address: FRASER MARTIN & MILLER LLC, 132 WEST SECOND STREET, PERRYSBURG, OH, 43551, US

(21) Appl. No.: 11/281,066

(22) Filed: Nov. 17, 2005

Related U.S. Application Data
(60) Provisional application No. 60/628,648, filed on Nov. 17, 2004.

(51) Int. Cl. H01R 13/40

(52) U.S. Cl. 439/595

(57) ABSTRACT

An electrical receptacle is disclosed wherein the front section is detachable for the replacement thereof. The front section includes a pair of posts, which extend through apertures formed in the rear section. A fastener is disposed on a distal end of the post to fasten the front section to the rear section. The front section is adapted to be used with existing receptacles.

### CROSS REFERENCE TO RELATED APPLICATION

This application claims priority to U.S. Provisional Application Ser. No. 60/628,648 filed on Nov. 17, 2004, the disclosure of which is hereby incorporated into this disclosure in its entirety.

### FIELD OF THE INVENTION

The invention relates to an electrical receptacle and more particularly an electrical receptacle wherein a front section is detachable for the replacement thereof.

### BACKGROUND OF THE INVENTION

Typically, an electrical receptacle is contained within an electrical box mounted in a wall or a ceiling on a stud. Installation of the receptacle is accomplished during construction of a building or other structure where the receptacle is to be used. After the structure is rough wired, a wall panel, such as dry wall, is installed, and the receptacle is thereby fixed in place and substantially inaccessible.

Occasionally, it is desirable to replace a front section of the electrical receptacle due to damage thereof, for example. Receptacles of the prior art have required replacement of both the front section and the rear section of the receptacle, even though the rear section may be undamaged and otherwise in working condition. This results in an unnecessary and undesirable additional expense.

It would be desirable to produce an electrical receptacle wherein a front section is detachable and separately replaceable, thereby minimizing a cost of replacement and a time required for replacement thereof.

### SUMMARY OF THE INVENTION

Consistent and consonant with the present invention, an electrical receptacle wherein a front section is detachable and separately replaceable, thereby minimizing a cost of replacement and a time required for replacement thereof, has surprisingly been discovered.

In one embodiment, a front section for the electrical receptacle comprises a front section having a plurality of openings formed therein adapted to receive prongs of an electrical plug therein; and an attachment device adapted to be disposed between and releasably fasten the front section and a rear section of the electrical receptacle to facilitate removal and replacement of the front section on the rear section.

In another embodiment, the electrical receptacle comprises a front section having an aperture formed therein; a rear section having an aperture formed therein; a post having a first end and a second end, the first end of the post disposed in the aperture of the front section and the second end of the post disposed in the aperture of the rear section; and a fastener disposed on the second end of the post to releasably fasten the front section to the rear section of the electrical receptacle.

In another embodiment, the electrical receptacle comprises a front section having at an aperture formed in a back thereof; a rear section including a mounting bracket and a housing, each of the mounting bracket and the housing having an aperture formed therein, the housing including a recess formed in a rear surface surrounding the aperture of the housing; a post having a first end and a second end, the first end of the post disposed in the aperture of the front section, the post extending through the aperture formed in the mounting bracket and the aperture formed in the housing; and a fastener disposed on the second end of the post in the recess of the housing to releasably fasten the front section to the rear section of the electrical receptacle.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is an exploded perspective view of an electrical receptacle according to an embodiment of the invention;

FIG. 2 is a perspective view of the electrical receptacle illustrated in FIG. 1; and

FIG. 3 is a rear elevational view of a rear section of the electrical receptacle illustrated in FIGS. 1 and 2.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

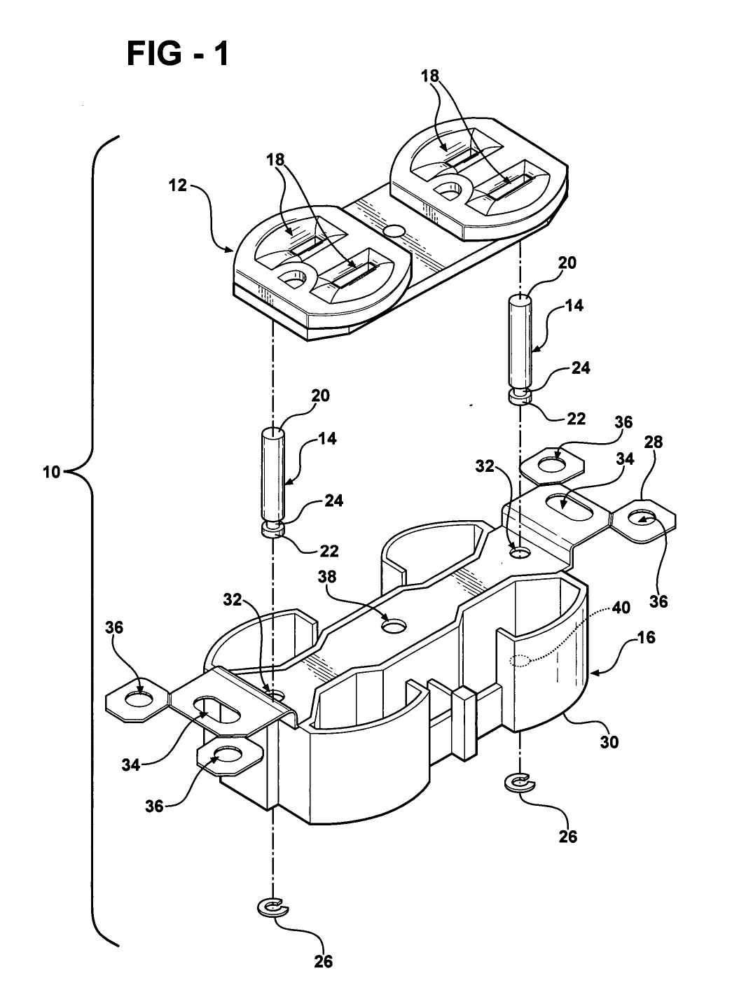

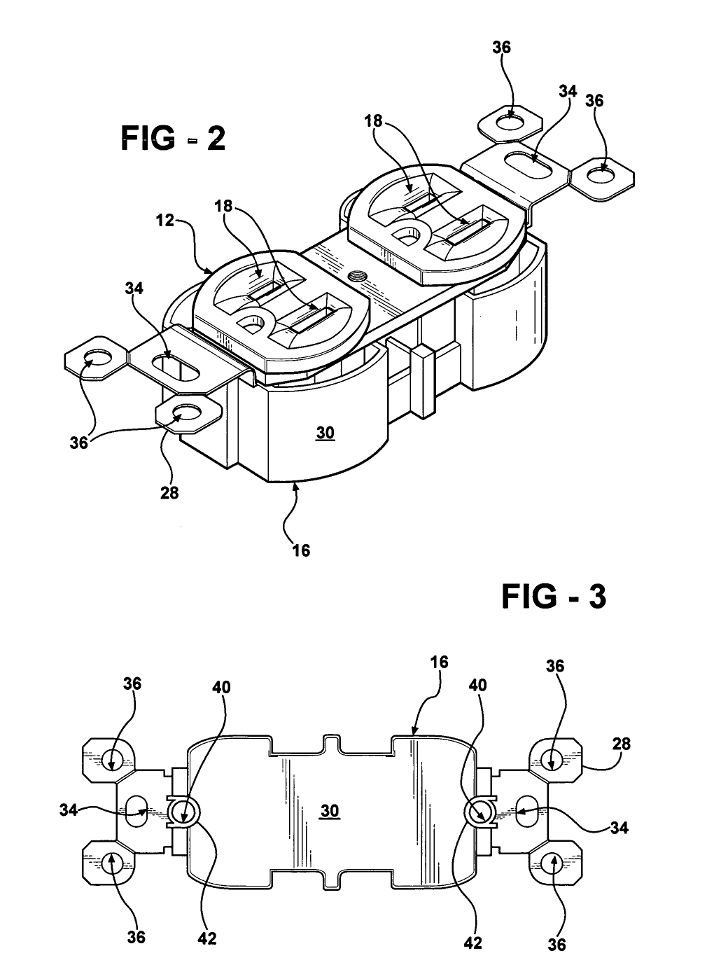

FIG. 1 shows an exploded view of an electrical receptacle 10 according to an embodiment of the invention. The electrical receptacle 10 includes a front section 12, a pair of posts or attachment devices 14, and a rear section 16.

The front section 12 has a front and a back. A pair of apertures (not shown) is formed in the back of the front section 12. Each of the apertures is adapted to receive one of the posts 14 therein. Openings 18 are formed in and extend through the front section 12 and are adapted to receive electrical plugs (not shown) therein. For exemplary purposes, a front section 12 for use with a three-prong electrical plug is shown.

The posts 14 have a first end 20 and a second end 22. As used herein, the definition of post is meant to include pins, screws, bolts, and the like, for example. The first end 20 of each of the posts 14 is adapted to be received in the apertures formed in the front section 12. In the embodiment shown, a groove 24 is formed adjacent the second end 22 of each of the posts 14. As used herein, the definition of groove is intended to include a channel, a passage, a conduit, an aperture, a hole, and the like, for example. The groove 24 is adapted to receive a fastener 26 therein. Although a clip type fastener 26 is shown, it is understood that other conventional fasteners such as a nut, a clamp, a gripping spring type, a self expanding spring type integral with the post 14, a pin, a key, a cotter pin, and the like, for example, can be used without departing from the scope and spirit of the invention.

The rear section 16 includes a mounting bracket 28 and a housing 30. The bracket 28 includes a pair of apertures 32 formed therein which receive the posts 14. Additional apertures 34, 36, 38 are formed in the bracket 28 to facilitate mounting of the electrical receptacle 10 and associated hardware (not shown).

The housing 30 has a hollow interior. Wiring connections (not shown) and other hardware can be attached to or mounted on the housing 30. Apertures 40, shown in FIG. 3, are formed in the housing 30 and are adapted to receive the second end 22 of the posts 14 therein. A recess 42 formed in a rear surface of the housing 30 receive the fasteners 26 and facilitate connection of the fasteners 26 to the posts 14. The rear section 16 is adapted to be installed in and connected to an electrical box (not shown). The remaining structure of the rear section 16 is known in the art, and thus will not be further described herein.

Assembly of the electrical receptacle 10 will now be described. The first end 20 of each of the posts 14 is inserted into one of the apertures of the front section 12. In the embodiment shown, the first end 20 of the post 14 is press fit into the aperture of the front section 12. However, it is understood that the posts 14 can be formed integrally with the front section 12 without departing from the scope and spirit of the invention.

The second end 22 of each of the posts 14 is inserted through the apertures 32 of the bracket 28 and the apertures 40 of the housing 30. The groove 24 is exposed on the back side of the housing 30 in the recess 42. The fastener 26 is disposed in the groove 24 and abuts a wall forming the recess 42 to releasably fasten the front section 12 to the rear section 16.

For other fastener types, appropriate changes to the post 14 can be made. For example, if a threaded nut is used as the fastener 26, a threaded portion can be added to the second end 22 of the post 14. If a self expanding spring type fastener is disposed on the second end 22 of the post 14, the post 14 can be inserted through the hole 28 until the self expanding fastener is exposed and permitted to expand, thus releasably fastening the front section 12 to the rear section 16. It is also understood that the fastener 26 can be positioned within the housing 30. Thus, additional structure within the housing 30 would be provided to abut the fastener 26 and releasably fasten the front section 12 to the rear section 16.

The front section 12 permits a replacement of the front section 12 without disconnecting electrical wires from the rear section 16, and without removing the rear section 16 from the electrical box. This minimizes the time required to change the front section 12. Additionally, cost savings result from replacing only the front section 12, instead of both the front section 12 and the rear section 16. The front section 12 is also adapted to be used with the rear section of existing electrical receptacles.

It is understood that the front section 12 can be made in different colors and patterns as well. Thus, as building colors and decor change, the front section 12 can also be changed to better match the new colors and decor, resulting in a more aesthetically pleasing fixture.

It is understood that other attachment devices 14 can be used to releasably attach the front section 12 to the rear section 16. Such attachment devices 14 may include detents, cooperating protuberances and recesses, spring loaded locking pins, and the like, for example.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A front section for an electrical receptacle comprising:
a front section having a plurality of openings formed therein adapted to receive prongs of an electrical plug therein; and
an attachment device adapted to be disposed between and releasably fasten said front section and a rear section of the electrical receptacle to facilitate removal and replacement of said front section on the rear section.

2. The front section according to claim 1, wherein said attachment device is a post having a first end and a second end, the first end of the post disposed in a back of said front section.

3. The front section according to claim 2, further comprising a fastener disposed on the second end of said the post.

4. The front section according to claim 3, wherein the post includes a groove formed in the second end thereof, the groove adapted to receive said fastener.

5. The front section according to claim 3, wherein the post includes a threaded section formed at the second end thereof and said fastener is a threaded nut.

6. The front section according to claim 3, wherein said fastener is one of a clip type, a pin type, a key type, and a spring type.

7. The front section according to claim 2, wherein said front section includes an aperture formed in the back thereof and the first end of the post is press fit into the aperture of the back of said front section.

8. An electrical receptacle comprising:
a front section having an aperture formed therein;
a rear section having an aperture formed therein;
a post having a first end and a second end, the first end of said post disposed in the aperture of said front section and the second end of said post disposed in the aperture of said rear section; and
a fastener disposed on the second end of said post to releasably fasten said front section to said rear section of the electrical receptacle.

9. The receptacle according to claim 8, wherein said post includes a groove formed in the second end thereof, the groove adapted to receive the fastener.

10. The receptacle according to claim 8, wherein said post includes a threaded section formed at the second end.

11. The receptacle according to claim 10, wherein said fastener is a threaded nut.

12. The receptacle according to claim 8, wherein said fastener is one of a clip type, a pin type, a key type, and a spring type.

13. The receptacle according to claim 8, wherein the first end of said post is press fit into the aperture of said front section.

14. An electrical receptacle comprising:
a front section having at an aperture formed in a back thereof;
a rear section including a mounting bracket and a housing, each of the mounting bracket and the housing having an aperture formed therein, the housing including a recess formed in a rear surface surrounding the aperture of the housing;
a post having a first end and a second end, the first end of said post disposed in the aperture of said front section, said post extending through the aperture formed in the mounting bracket and the aperture formed in the housing; and
a fastener disposed on the second end of said post in the recess of the housing to releasably fasten said front section to said rear section of the electrical receptacle.

15. The receptacle according to claim 14, wherein said post includes a groove formed in the second end thereof, the groove adapted to receive the fastener.

16. The receptacle according to claim 14, wherein said post includes a threaded section formed at the second end.

17. The receptacle according to claim 16, wherein said fastener is a threaded nut.

18. The receptacle according to claim 14, wherein said fastener is one of a clip type, a pin type, a key type, and a spring type.

19. The receptacle according to claim 14, wherein the first end of said post is press fit into the aperture of said front section.
